(19) United States
(12) Patent Application Publication
(10) Pub. No.: US 2015/0193715 A1
(43) Pub. Date: Jul. 9, 2015

(54) SYSTEMS AND METHODS FOR PROVIDING TRANSACTION PROCESSING INSTRUCTIONS BASED ON PRODUCT AND USER IDENTIFICATION

(71) Applicant: Toshiba Global Commerce Solutions Holdings Corporation, Tokyo (JP)

(72) Inventors: David Bernath, Cary, NC (US); Jeffrey J. Smith, Raleigh, NC (US); Julia Bond, Youngsville, NC (US)

(73) Assignee: Toshiba Global Commerce Solutions Holdings Corporation, Tokyo (JP)

(21) Appl. No.: 14/189,283

(22) Filed: Feb. 25, 2014

Related U.S. Application Data
(60) Provisional application No. 61/923,843, filed on Jan. 6, 2014.

(51) Int. Cl. G06Q 10/06; G06Q 20/20

(52) U.S. Cl. CPC G06Q 10/06316; G06Q 20/208

(57) ABSTRACT

Systems and methods for targeting an appropriate level of instructions to an associate of a point of sale device are disclosed. According to an aspect, a method may be implemented at a computing device comprising a processor and memory. The method includes initiating a transaction associated with a product identifier. The method also includes identifying a user associated with the transaction. The method also includes determining multiple transaction processing instructions for the product identifier. The method also includes selecting one or more of the transaction processing instructions based on product identifier and the identified user. Further, the method includes presenting one or more of the transaction processing instructions.

### CROSS REFERENCE TO RELATED APPLICATION

This application claims the benefit of U.S. Provisional Patent Application No. 61/923,843, filed Jan. 6, 2014 and titled SYSTEMS AND METHODS FOR PROVIDING TRANSACTION PROCESSING INSTRUCTIONS BASED ON PRODUCT AND USER IDENTIFICATION, the content of which is hereby incorporated herein by reference in its entirety.

### TECHNICAL FIELD

The present invention relates to retail devices and equipment, and more specifically, to systems and methods for providing transaction processing instructions based on product and user identification.

### BACKGROUND

In retail environments, such as electronic, home improvement, clothing stores, and other “brick and mortar” stores, as examples, retail personnel interact with and aid customers in the purchase of products. In today's retail environment the point-of-sale (POS) systems are becoming integrated with the interaction the retail personnel have with the customers. POS systems are no longer just limited to a traditional cash register and are further linked to information about the products, store inventories, and the customer. As an example, it is often helpful to provide instructions regarding the products of interest to the customer to the associates to help them perform their job better and provide the needed information to the customer at an appropriate level. Types of instructions that may be helpful may be managed or adjusted based on the context of and/or the type of the transaction. For example, upon check out with a customer purchasing a suitcase, it may be important to the retail store to insure the associate checks the inside of the suitcase for items the customer may have placed inside while shopping. Whether this is intentional or unintentional, if the item placed inside the suitcase is not correctly processed or purchased, the retail store can incur a loss and inventory errors can result.

A POS device may be configured to provide instructions for each transaction and product type to make sure the associate does not overlook critical steps that could help with loss-prevention or errors in sales entry. It is important to provide the right information to the associate. In view of this need, there is a desire to provide improved POS interfaces and information at POS devices.

### SUMMARY

Disclosed herein are systems and methods for providing transaction processing instructions based on product and user identification. According to an aspect, a method may be implemented at a computing device comprising a processor and memory. The method includes initiating a transaction associated with a product identifier. The method also includes identifying a user associated with the transaction. The method also includes determining multiple transaction processing instructions for the product identifier. The method also includes selecting one or more of the transaction processing instructions based on product identifier and the identified user. Further, the method includes presenting one or more of the transaction processing instructions.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system targeting an appropriate level of instructions to a user of a POS device according to embodiments of the present invention;

FIG. 2 is a block diagram of an example database and tables used to present the right instructions for processing a product transaction to the user of a POS device based on the experience level of the user according to embodiments of the present invention;

FIG. 3 is a flowchart of an example method for targeting the right instructions for processing a product transaction to the user of a POS device based on the experience level or transaction type of the user of the POS device in accordance with embodiments of the present invention; and

FIG. 4 is a block diagram of an example user interface showing multiple levels of instruction wherein each level may be presented based on the user associated with the product transaction.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

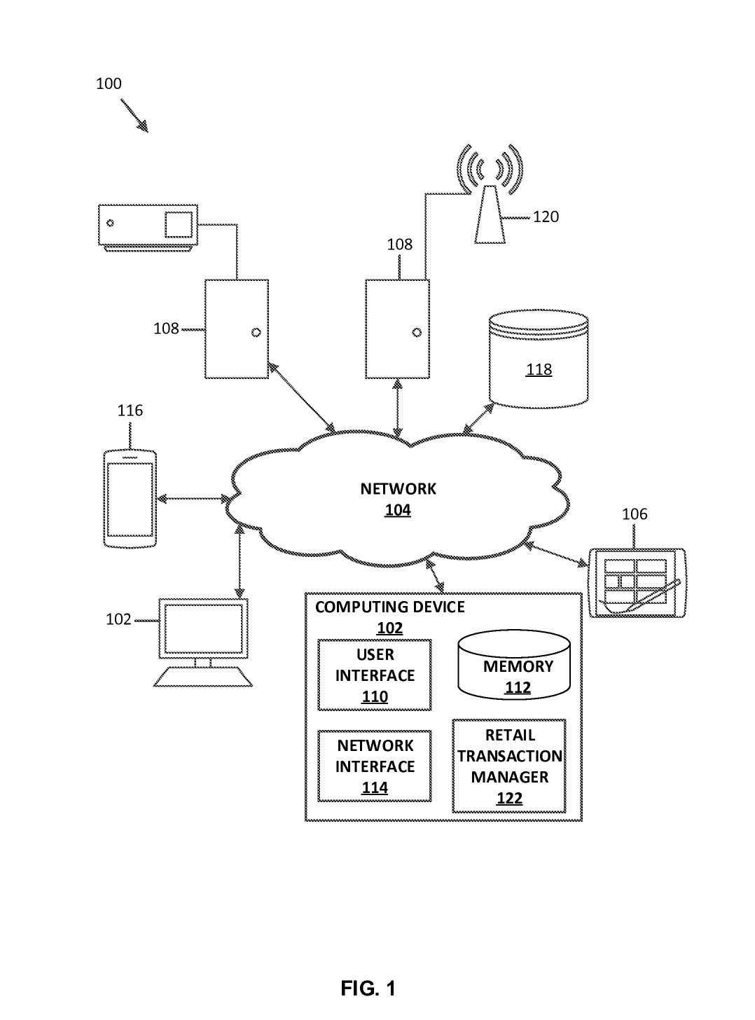

The presently disclosed invention is now described in more detail. FIG. 1 illustrates a block diagram of a system 100 according to embodiments of the present invention. The system 100 may be implemented in whole or in part in any suitable environment, such as a retail environment. For example, the system 100 may be implemented in a retail store having a variety of products or items for purchase and one or more POS terminals. For example, each computing device 102 may be configured to operate as a POS device that can be operated by retail personnel for conducting purchase transactions with customers or for otherwise processing products within the retail environment (e.g., inventory of products). The computing devices 102 may each be communicatively connected via a communications network 104, which may be any suitable local area network (LAN), either wireless (e.g., BLUETOOTH® communication technology) and/or wired. The computing device 102, a tablet device 106 in communication with one of the computing devices 102, and other components, not shown, may be configured to acquire data within the retail environment, to process the data, and to communicate the data to a centralized server 108. For example, the computing device 102 and its tablet device 106 may operate together to implement a retail function and to communicate data related thereto to the server 108. The server 108 may reside in the retail store or be remotely located.

The components of the system 100 may each include hardware, software, firmware, or combinations thereof. For example, software residing in memory of a respective component may include instructions implemented by a processor for carrying out functions disclosed herein. As an example, one of the computing devices 102 shows a detail of example components including a user interface 110 having such components as a display (e.g., a touchscreen display), a barcode scanner, and/or other equipment for interfacing with retail personnel and for conducting a purchase transaction for purchase of items by customers. The computing device 102 may also include memory 112. The computing device 102 may be configured to implement POS functionality. The computing device 102 may also include a suitable network interface 114 for communicating with the network 104. The tablet device 106 may include hardware (e.g., image capture devices, scanners, and the like) for capture of various data within the retail environment. For example, the tablet device 106 may include an image capture device (e.g., a camera) for capturing one or more images of a retail item (e.g., a product) and interaction of a user's hand or finger with the item. In another example, the tablet device 106 may include a scanner for scanning items for inventory or for POS functions (e.g., customer purchase of a scanned product). The system 100 may also include a smart phone device 116 configured with functionality similar to the tablet device 106. The system 100 may also include a database 118 for storage of online orders, sales order, and transaction history. Further, for example, the server 108 may be connected to the computing devices 102 via the network 104 or via a wireless network 120.

In continuing reference to FIG. 1, the system 100 may be used for targeting an appropriate level of instructions to a user of a POS device according to embodiments of the present invention. As an example, the computing device 102 may include a retail transaction manager 122 for targeting an appropriate level of instruction to a user of POS functionality on the computing device 102. As will be described in further detail herein, the retail transaction manager 122 may be implemented by suitable hardware, software, firmware, or combinations thereof, such as one or more processors and memory having computer readable instructions stored therein. The retail transaction manager may be configured to target an appropriate level of instruction based on a product, transaction type, and/or experience level of the user of the device. The retail transaction manager 122 may initiate a transaction associated with a product identifier. The product identifier may be a product number, serial number, model number, or other code which identifies the product pertaining to a current transaction. Initiation of the transaction associated with the product identifier may begin by reading or otherwise entering the product identifier. The tablet device 106 may comprise hardware (e.g., image capture devices, scanners, and the like) for capturing various data within the retail environment for the reading or entering of the product identifier. For example, the tablet device 106 may include an image capture device (e.g., a still or video camera) for capturing one or more images of a product identifier (e.g., product number or UPC code) or interaction of a user's hand or finger with a displayed keyboard on the tablet device 106. In another example, the tablet device 106 may include a scanner for scanning items. Further, the retail transaction manager 122 may identify a user associated with the transaction associated with the product identifier. The user may be an associate, employee or customer of the retail store operating the POS device. The user may or may not be known to the retail store. If the user is known to the retail store, there may be an associated level of experience based on the product identifier and transaction type. Based on the user's experience level with the product identifier and the transaction type, the retail transaction manager 122 may determine multiple transaction processing instructions for the product identifier. The retail function manager 122 may select one or more of the transaction processing instructions based on the product identifier and the identified user and present the transaction processing instruction(s) to the user for the processing of the current transaction.

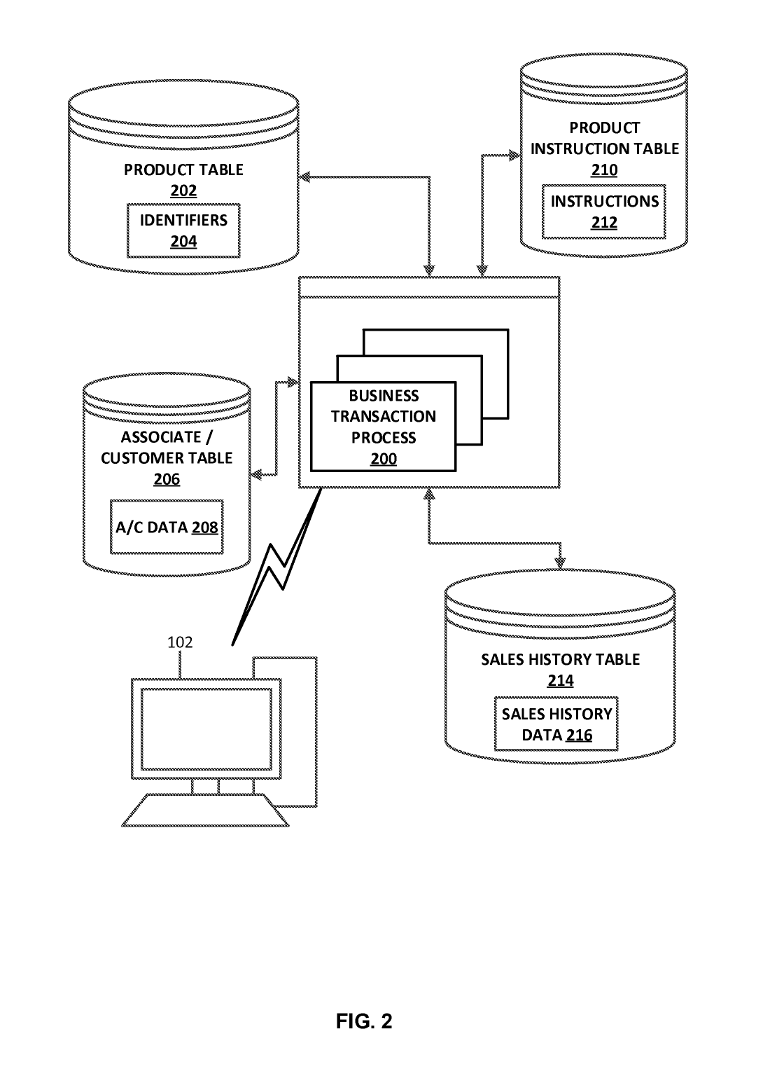

In this regard, FIG. 2 is a block diagram illustrating an example data model of a retail transaction process 200 in accordance with embodiments of the present invention. As an example, the retail transaction process 200 may be implemented by the retail transaction manager 122 shown in FIG. 1. The retail transaction process 200 may facilitate the processing of a retail transaction. The retail transaction process 200 may include, but is not limited to, the sale, return, exchange, and the future processing of a retail transaction. The future processing of the retail transaction may include the future purchase of a product associated with a product that has been previously purchased. For example, a printer ink cartridge may be purchased in a future retail transaction for a printer, and the printer may have been previously purchased. The retail transaction process 200 may use product, user (e.g., associate or customer), and/or customer sales data supporting the retail transaction. The data used in the process 200 may include a product table 202 for storing product identifiers 204. The used data may also include an associate/customer table 206 for storing associate/customer data 208, such as, experience levels, identification numbers (e.g., employee numbers, customer loyalty numbers, and the like), buying habits, and/or the like. Additionally, the retail transaction process 200 may utilize a product instruction table 210 for storing instructions 212 associated with the product identifiers 204 in the product table 202.

With continued reference to FIG. 2, each product handled by an associate, whether it is an item being sold, returned, or exchanged, may have displayed transaction processing instructions 212 corresponding with that particular product transaction (e.g., sale, return, exchange, and the like) for the particular product identifier 204 based on the experience of a particular associate or even customer. The number of displayed product instructions may vary based on the experience or other criteria of the particular associate, wherein the experience or other criteria corresponds to the stored associate/customer data 208. The experience level of the associate or identified user may be determined by a count that corresponds to the number of transactions the identified user has had with a particular transaction type that is currently initiated by the retail transaction manager 122 in the computing device 102 or the tablet device 106. As the identified user gains more experience the count may be incremented and stored in the associate/customer table 206 associated with the identified user. As the identified user gains more experience as indicated by an incremented count associated with a particular transaction type or product identifier 204, the retail transaction manager 122 can be configured to modify the displayed transaction processing instructions 212 based on the count. Modifying the displayed transaction processing instruction 212 may include adjusting the level of detail or length of the displayed transaction processing instructions 212. Adjusting the detail or length of the displayed transaction processing instructions 212 may include adjusting the displayed transaction processing instructions 212 to include more or less detail (e.g., more specific steps, longer or shorter instructions, and the like).

With continued reference to FIG. 2, as an example, a transaction type may include a product identifier 204 corresponding to a suitcase being purchased. Exemplary transaction processing instructions 212 may be presented to remind an associate or identified user, to check inside the suitcase to insure no other items have been hidden inside it (e.g., loss prevention step). A lesser experienced associate or identified user, as indicated by a lower count with a transaction type or product identifier than the count corresponding to the more experienced associate, may need to be presented with a more detailed transaction processing instruction 212. The more detailed transaction processing instruction 212 may include both a description of the task, such as describing checking in the main part of the suitcase, as well as side pockets complimented also by a photo or image of the task. On the other hand, the more experienced associate as indicated by a higher count with a particular transaction type or product identifier, may only need presentation of a brief transaction processing instruction 212 such as a simple reminder to “check the bag.” An additional example may involve verifying that a software package has not been opened (e.g., seals are intact) when returning the software package. A more detailed transaction processing instruction 212 may cause the retail transaction process 200 to halt until the lesser experienced associate verifies that the package is still sealed as opposed to the more experienced associate, wherein the transaction processing instruction 212 may only comprise a reminder. In this example, it may be that the retail transaction process 200 requires an associate's supervisor or other authorized retail personnel to approve that the transaction processing instruction(s) 212 have been properly completed based on particular product identifiers 204. As the store may have a policy of no returns allowed (only exchanges) for an open product or have a particular policy based on monetary value of a sale, return or exchange, as an example. The transaction processing instructions 212 may also be determined or modified based on the transaction type. As an example, the same transaction processing instruction 212 may be modified or deemed not to apply at all if the item was being returned or exchanged.

With continued reference to FIG. 2, as described above, retrieving a record of the identified user associated with the transaction may include determining the transaction processing instructions based on the record of the identified user. The identified user may be an associate or a customer of the retail establishment. The retrieved record of the identified user may include the experience level of the associate with the product identifier or a transaction type. As an example, the experience level may be determined by the count or number of transactions previously processed by the associate. The experience level as indicated by the count of the associate may also be determined by training attended or years of employment. The experience level as indicated by the count may also be determined by the title, role or employment level within the retail establishment. Further, in the case where the identified user is a customer, the retrieved record of the identified user may comprise previous transaction types (e.g., sales, returns, exchanges, and the like) or product identifiers purchased, returned, exchanged or otherwise processed. The transaction processing instructions presented may be based on the retrieved record of the identified user.

With continued reference to FIG, 2, additional tables may be used by the retail transaction process 200. For example, a customer sales history table 214 may be used to store sales history data 216 associated with the customer and the product identifier 204. Customer sales history may comprise previous transaction types (e.g., sales, returns, exchanges, and the like), products and/or product identifiers purchased, dates, and/or the like for the customer. The products and/or product identifiers stored in the customer sales history table may also be referred to as historical products and/or product identifiers. The retail transaction process 200 may modify the displayed transaction processing instructions 212 based on the customer sales history data 216 stored in the customer sales history table 214. In this manner, the retail transaction process 200 nay modify the displayed transaction processing instructions 212 to prompt the associate to ask the customer more or fewer questions based on either the current product identifier 204 being transacted or past product identifiers 204 purchased by the customer. As an example, if the customer corresponding to the associate/customer data 208 purchased a printer last month and is presently purchasing a printer ink cartridge, the retail transaction process 200 may determine whether the present purchase of the printer ink cartridge is supported by the printer purchased last month. In this example, the displayed transaction processing instruction 212 may alert the associate to ask the customer whether this is for the printer purchased last month based on the customer sales history data 216 stored in the customer sales history table 214. Based on the alert, the associate may be able to inform the customer that the printer s/he purchased does not support or correspond to the printer ink cartridge presently being purchased. Further, the retail transaction process 200 may also be configured to alert the associate to ask the customer about the purchase of other products or product identifiers associated or that correspond with the product identifier 204 presently being purchased, where the product identifier 204 presently being purchased corresponds to a historical product identifier 204 in the retrieved customer sales history. in this example, the associate may be prompted to inform the customer of other product identifiers 204 that other customers have purchased that the customer may also have interest in purchasing. Thus, the customer sales history may serve to alert the associate and/or the customer that either a problem and/or an additional sales opportunity exists with the product identifier 204. The product identifier 204 may be fix a specific product or a group of products. The product identifier 204 may indicate a particular product or a family of related products.

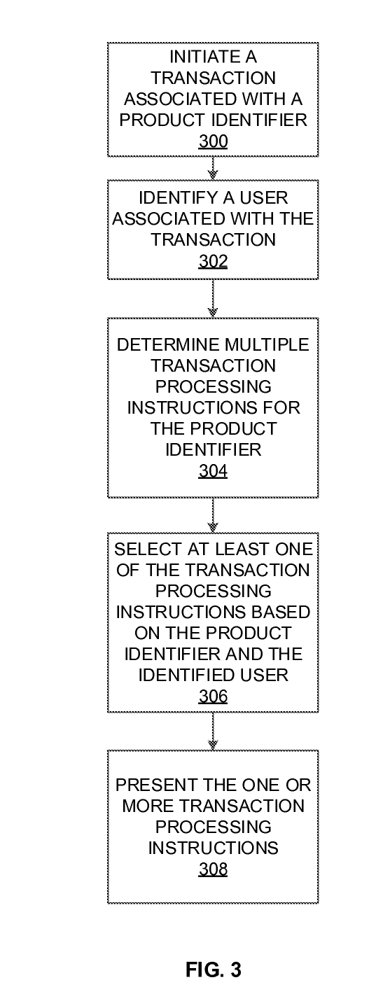

FIG. 3 illustrates a flowchart of an example retail transaction process in accordance with embodiments of the present invention. The process may be implemented by, for example, the retail transaction manager 122 on the computing device 102 shown in FIG. 1, or any other suitable device. In this example, reference is made to the examples of FIGS. 1 and 2, but it should be understood that the process or method may be implemented in any other suitable system.

Referring to FIG. 3, the method includes initiating 300 a transaction associated with the product identifier 204. For example, the method may be initiated by the retail transaction manager 122 to begin the retail transaction process. Further, the method may include identifying 302 a user associated with the transaction. For example, the retail transaction manager 122 may identify a user associated with the transaction. The user associated with the transaction may be an associate, employee or customer of the retail establishment.

The method of FIG. 3 includes determining 304 multiple transaction processing instructions for the product identifier. Continuing the aforementioned example, the retail transaction manager 122 may be configured to determine multiple transaction processing instructions for the product identifier 204 (block 304). Transaction processing instructions 212 may be stored in the product instruction table 210.

The method of FIG. 3 includes selecting 306 at least one of the transaction processing instructions based on the product identifier and the identifier user. Continuing the aforementioned. example, the retail transaction manager 122 may be configured to select one or more of the transaction processing instructions based on product identifier 204 and the identified user. Further, the method of

FIG. 3 may include presenting 308 the one or more transaction processing instructions. Continuing the aforementioned example, the retail transaction manager 122 may present the transaction processing instruction(s) to the user. For example, the instruction(s) may be displayed to a user on a display of the user interface 110.

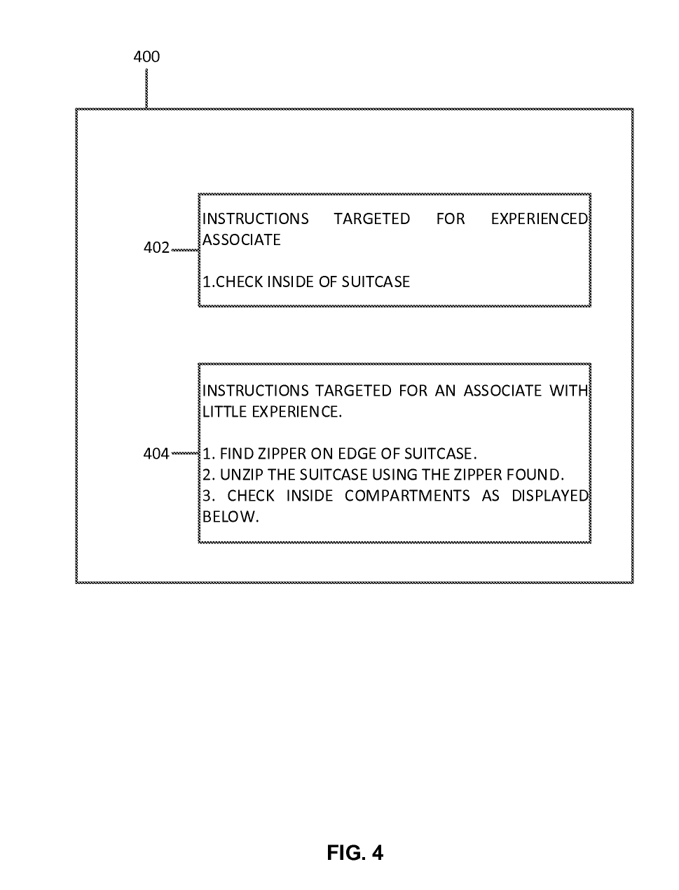

FIG. 4 illustrates a display 400 of a computing device in accordance with embodiments of the present invention. In this example, the display of information on the display 400 may be implemented by a retail transaction manager 122 of the computing device 102 shown in FIG. 1, although it should be understood that it may be implemented by any suitable computing device. The display 400 may be part of the user interface 110 shown in FIG. 1. Initially, for example, the retail transaction manager 122 may control the display 400 to display transaction processing instructions 212 corresponding to the product instruction table 210 and the associate/customer data 208 shown in FIG. 2. In this example, the transaction processing instructions 212 may be limited according to the experience as determined by the associate/customer data 208 in the associate/customer table 206, Referring to FIG. 4, display portion 402 shows instructions that may be displayed for an experienced user. in contrast, display portion 404 shows instructions that may be display for an inexperienced user. The instructions in display portion 404 may include the additional transaction processing instructions 212 displayed when a lesser experienced associate, as indicated by a count, has been determined to be the identified user by the retail transaction manager 122. The transaction processing instructions 212 may be initially presented or displayed in the display portions 402 and 404, wherein the transaction processing instruction 212 may be hidden. The user interface 402 and 404 may be minimized or displayed upon the click of a link or key press.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
using at least one processor and memory for:
initiating a transaction associated with a product identifier;
identifying a user associated with the transaction;
determining a plurality of transaction processing instructions for the product identifier;
selecting at least one of the transaction processing instructions based on the product identifier and the identified user; and
presenting the at least one of the transaction processing instructions.

2. The method of claim 1, further comprising using the at least one processor and memory for receiving the product identifier at a point of sale terminal.

3. The method of claim 1, further comprising using the at least one processor and memory for receiving a transaction type, and wherein determining the plurality of transaction processing instructions comprises determining the plurality of transaction processing instructions based on the transaction type.

4. The method of claim 1, further comprising using the at least one processor and memory for retrieving a record of the identified user associated with the transaction, and wherein determining the plurality of transaction processing instructions comprises determining the plurality of transaction processing instructions based on the record of the identified user.

5. The method of claim 1, further comprising using the at least one processor and memory for determining an identifier of a customer associated with the transaction.

6. The method of claim 5, further comprising using the at least one processor and memory for retrieving a customer sales history based on the identifier of the customer, and wherein determining the plurality of transaction processing instructions comprises determining the plurality of transaction processing instructions based on the customer sales history.

7. The method of claim 6, further comprising displaying an alert in response to the product identifier not corresponding to a historical product identifier in the retrieved customer sales history.

8. The method of claim 6, further comprising displaying an alert in response to the product identifier corresponding to a historical product identifier in the retrieved customer sales history

9. The method of claim 1, further comprising using the at least one processor and memory for incrementing a count corresponding to the identified user based on each initiated transaction associated with the product identifier.

10. The method of claim 9, further comprising modifying the displayed transaction processing instructions based on the count.

11. A computing device comprising:
at least one processor and memory; and
a retail transaction manager configured to:
initiate a transaction associated with a product identifier;
identify a user associated with the transaction;
determine a plurality of transaction processing instructions for the product identifier;
select at least one of the transaction processing instructions based on product identifier and the identified user; and
present the at least one of the transaction processing instructions.

12. The computing device of claim 11, wherein the retail transaction manager is configured to receive the product identifier at a point of sale terminal.

13. The computing device of claim 11, wherein the retail transaction manager is configured to:
receive a transaction type; and
determine the plurality of transaction processing instructions based on the transaction type.

14. The computing device of claim 11, wherein the retail transaction manager is configured to:
retrieve a record of the identified user associated with the transaction; and
determine the plurality of transaction processing instructions based on the record of the identified user.

15. The computing device of claim 11, wherein the retail transaction manager is configured to determine an identifier of a customer associated with the transaction.

16. The computing device of claim 15, wherein the retail transaction manager is configured to:
retrieve a customer sales history based on the identifier of the customer; and
determine the plurality of transaction processing instructions based on the customer sales history.

17. The computing device of claim 16, wherein the retail transaction manager is configured to display an alert in response to the product identifier not corresponding to a historical product identifier in the retrieved customer sales history.

18. The computing device of claim 16, wherein the retail transaction manager is configured to display an alert in response to the product identifier not corresponding to a historical product identifier in the retrieved customer sales history.

19. The computing device of claim 11, wherein the retail transaction manager is configured to increment a count corresponding to the identified user based on each initiated transaction associated with the product identifier.

20. The computing device of claim 19, wherein the retail transaction manager is configured to modify the displayed transaction processing instructions based on the count.

21. A computer program product comprising a computer readable storage medium having program instructions embodied therewith, the program instructions readable by a computing device to cause the computing device to:
initiate, at the computing device, a transaction associated with a product identifier;
identify, at the computing device, a user associated with the transaction;
determine, at the computing device, a plurality of transaction processing instructions for the product identifier;
select, at the computing device, at least one of the transaction processing instructions based on product identifier and the identified user; and
present, at the computing device, the at least one of the transaction processing instructions.
